(19) United States
(12) Patent Application Publication
(10) Pub. No.: US 2010/0257962 A1
(43) Pub. Date: Oct. 14, 2010

(54) DOUBLE CLUTCH TRANSMISSION

(75) Inventors: Philip RECKER, Friedrichshafen (DE); Gerhard GUMPOLTSBERGER, Friedrichshafen (DE); Wolfgang RIEGER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/758,962

(22) Filed: Apr. 13, 2010

(30) Foreign Application Priority Data
Apr. 14, 2009 (DE) 10 2009 002 346.1

(51) Int. Cl. F16H 3/20

(52) U.S. Cl. 74/331

(57) ABSTRACT

A double clutch transmission with two clutches with input sides connected to a drive shaft and output sides respectively connected to one of two transmission input shafts disposed coaxially to each other. At least two countershafts are provided, upon which toothed idler gearwheels are mounted in a rotatable manner, and toothed fixed gearwheels are disposed on the two transmission input shafts in a rotationally fixed manner. At least one shift element is provided for connecting two toothed gearwheels in a rotationally fixed manner, and at least multiple power shift forward gears and/or at least one reverse gear can be shifted. Six gear planes are provided so that at least one power shift winding path gear is shifted via at least one shift element.

This application claims priority from German patent application serial no. 10 2009 002 346.1 filed Apr. 14, 2009.

### FIELD OF THE INVENTION

The present invention relates to a double clutch transmission.

### BACKGROUND OF THE INVENTION

A six or seven speed double clutch transmission is known from the published patent DE 103 05 241 A1. The double clutch transmission comprises two clutches each having their input side connected to the driveshaft, and their output side connected to one of the two transmission input shafts. The two transmission input shafts are disposed coaxially to each other. In addition, two countershafts are disposed axially parallel to the two transmission input shafts, whose idler gears mesh with fixed gears of the transmission input shafts. Furthermore, coupling devices that are axially movable are held in a rotationally fixed manner on the countershafts, in order to be able to shift to the respective toothed gearwheel. The respectively selected transmission ratio is transferred via the output gears to a differential. In order to realize the desired transmission ratio steps for the known double clutch transmissions, a plurality of gear planes is necessary such that significant construction space is required during installation.

Further, a spur-gear multi-speed transmission is known from the published patent DE 38 22 330 A1. The spur-gear multi-speed transmission comprises a double clutch transmission that can be shifted under load, and has one part is connected to driveshaft and an other part connected to a hollow driveshaft, this is rotatably supported on the driveshaft. The driveshaft can be coupled to the hollow driveshaft via a shift element for specific transmission ratios.

A power shift transmission with two clutches, which are each assigned a subtransmission, is known from the published patent DE 10 2004 001 961 A1. The transmission input shafts of the two subtransmissions are disposed coaxially to each other and via fixed gears mesh with idler gears of the associated countershafts. The respective idler gears of the countershafts can be connected to the respective countershaft in a rotationally fixed manner by means of the associated shift element. From this patent document, an eight speed transmission is known in which a further shift element is provided for coupling the two transmission input shafts in order to realize a further transmission ratio step. Even the eight speed transmission with this embodiment requires at least six gear planes in the two subtransmissions in order to realize the transmission ratio steps. This leads to an undesired elongation of the overall construction length in the axial direction such that the installation possibilities in a vehicle are severely restricted.

In addition, from the published patent DE 10 2005 028 532 A1, a further power shift transmission is known which comprises two input shafts and only one countershaft. A nine speed transmission in this embodiment requires, for example, at least seven gear planes in order be able to realize the transmission ratio steps. This leads to an undesired elongation of the overall construction length in the axial direction. In addition, for implementing the reverse gear transmission ratios, an additional shaft with a gear plane is required that comprises a shift element and two toothed gears. A further disadvantage results with the known power shift transmission in that power shifting is only possible between the first and second gear.

### SUMMARY OF THE INVENTION

The present invention relates to the problem of proposing a double clutch transmission of the initially described type, in which multiple power shift transmission ratios are realized as cost-effectively as possible, and with as few components as possible, with a low construction space requirement.

Accordingly, a double clutch transmission that is optimized for construction space, having two clutches is proposed, whose input sides are connected to a driveshaft, and whose output sides are connected respectively to one of two transmission input shafts disposed coaxially to each other. The double clutch transmission comprises at least two countershafts or similar, on which toothed gearwheels formed as idler gears are mounted in a rotational manner, wherein toothed gearwheels, which mesh at least in part with the idler gears, are disposed on both transmission inputs shafts in a rotationally fixed manner, and are formed as fixed gears. Further, multiple coupling devices are provided for connection of an idler gear to a countershaft in a rotationally fixed manner. The double clutch transmission according to the invention has, in each case, an output gear or constant pinion, provided at each of the countershafts, that in each case, is coupled to gearing of a driveshaft to connect the respective countershaft to the output drive, and at least one shift element or similar that can be activated or engaged as a so-called winding path gear-shift element for the rotationally fixed connection of two toothed gearwheels, wherein at least multiple forward power shiftable gears and/or at least one reverse power shiftable gear are feasible.

The proposed double clutch transmission according to the invention preferably comprises only six gear planes, with which at least nine forward power shiftable gears can be realized with low construction space requirements.

For example, the six gear planes can be formed by at least three dual gear planes and three single gear planes, wherein in each dual gear plane respectively one idler gear of the first and second countershafts are assigned a fixed gear of one of the transmission input shafts, and at least one idler gear can be used for at least two gears, such that at least one power shiftable winding gear path can be shifted using at least one shift element. Other configurations are also possible.

Due to the possible multiple uses of idler gears with the proposed double clutch transmission, a maximum number of transmission ratios can be realized with the fewest possible gear planes, wherein preferably all forward gears can be power shifted in sequential implementation, and/or at least a reverse gear and at least a crawler gear can be power shifted.

To optimize the stepping with the proposed double clutch transmission according to the invention a dual gear plane can be replaced by two individual gear planes, in that one fixed gear is replaced by two fixed gears. Thereby, particularly harmonic, progressive gear stepping can be attained. It is also possible to replace two single gear planes by a dual gear plane.

The proposed double clutch transmission can preferably the implemented as a nine speed transmission with at least nine power shiftable gear steps. Due to the short construction compared to known transmission arrangements, the double clutch transmission according to the invention is particularly suited for a front transverse construction in a vehicle. However, other installations are also possible depending on the type and construction space of the respective vehicle in question. Preferably, with the proposed double clutch transmission, the ninth forward gear can be a winding path gear. Accordingly, the highest power shiftable gear can be a winding path gear. In addition, at least one reverse and/or further gears, for instance, crawler gears, can also be implemented as a winding path gear. Preferably, reverse gears are also implemented power shiftable among themselves.

As an example, depending on the embodiment, the first countershaft, for example, can be assigned three or four shiftable idler gears, and the second countershaft can be assigned five or six shiftable idler gears, which in each case mesh with fixed gears of the assigned transmission input shaft.

If the last or next-to-last gear increment is higher than the respectively previous one, a particularly high drive torque or drive power can be made available, in the event of a downshift requested by the driver.

In an advantageous manner with the double clutch transmission according to the invention, at most seven shift positions are necessary on a countershaft. In total, only 10 shift positions are used together on the two countershafts in order to realize the proposed gear steps.

According to the invention it, can be provided that by means of at least one shift element on the second countershaft, an idler gear of the second subtransmission can be connected to an idler gear of the first subtransmission, wherein via the shift element the ninth forward gear, and/or a reverse gear and/or at least a crawler gear can be shifted respectively as a winding path gear.

Furthermore, it can be provided by means of an alternate or additional shift element on the first countershaft, that the idler gear of the second subtransmission can be connected to the idler gear of the first subtransmission, so that via the shift element at least a reverse gear and/or at least a crawler gear can be shifted respectively as a winding path gear.

Consequently, using at least one shift element, with the double clutch transmission according to the invention, winding path gears can be realized, in which toothed gearwheels of both subtransmissions are coupled together in order to thereby realize a flow of power through both subtransmissions. Here, the shift element used in each case serves to couple two idler gears, and thereby brings the transmission input shafts into dependency on each other.

In the double clutch transmission, the arrangement of the shift elements for coupling of two specific idler gears can be varied so that the shift elements need not necessarily be disposed between the idler gears to be coupled. Accordingly, other arrangement positions of the respective shift elements are conceivable, in order to optimize, for example, linking to an actuator system.

With the double clutch transmission according to one possible embodiment, it can be provided that the first gear plane and the second gear plane respectively are single gear planes, and the third gear plane is a dual gear plane and comprise three fixed gears on the second transmission input shaft of the second subtransmission, wherein the fourth gear plane and the fifth gear plane in each case being dual gear planes and the sixth gear plane being a single gear plane comprise three fixed gears on the first transmission input shaft of the first subtransmission.

In the scope of a further variant embodiment of the invention, it can also be provided with the proposed double clutch transmission that the first gear plane being a single gear plane, and the second gear plane and the third gear plane respectively being dual gear planes, comprise three fixed gears on the second transmission input shaft of the second subtransmission, wherein the fourth gear plane being a single gear plane and the fifth gear plane being a dual gear plane and the sixth gear plane being a single gear plane comprise three fixed gears on the first transmission input shaft of the first subtransmission.

In order to provide the necessary reversal of rotation for implementing reverse gears with the double clutch transmission according to the invention, for example, at least one intermediate gear or similar can be used that is disposed e.g. on an intermediate shaft. It is also possible that one of the idler gears of a countershaft serves as an intermediate gear for at least one reverse gear. No additional intermediate shaft is necessary then for the reverse gear transmission ratio because one of the idler gears meshes both with a fixed gear as well as with a further shiftable idler gear of the other countershaft. Consequently, the intermediate gear required for the reverse gear is disposed as a shiftable idler gear on a countershaft, and serves to implement at least one further forward gear. The intermediate gear can also be implemented as a stepped gear independent of whether this is disposed on the counter shaft or on an additional intermediate shaft. Is also possible that the intermediate gear is not disposed on one of the countershafts that are already present, rather example, is provided on a further separate shaft, e.g. a third countershaft.

In order to obtain the desired transmission ratio steps it can be provided with the double clutch transmission according to the invention that at least one bidirectionally operative coupling device or similar is disposed at each countershaft. The provided coupling devices in the activated or engaged state, depending on the direction of actuation can connect an associated idler gear to the countershaft in a rotationally fixed manner. In addition, a unidirectionally operative coupling device or similar can also be disposed on at least one of the countershafts. As coupling devices, for example, hydraulically, electrically, pneumatically, or mechanically actuated clutches or also form-locking jaw clutches, as well as any type of synchronization, can be used, which serve for the rotationally fixed connection of an idler gear to a countershaft. It is also possible to replace a bidirectionally operative coupling device by two unidirectionally operative coupling devices or vice versa.

With the proposed double clutch transmission, it is conceivable that the specified arrangements of the toothed gear wheels vary, and also the number of toothed gearwheels as well as the number of coupling devices are changed in order to realize still further gears that can, or cannot, be power shifted, as well as to realize construction space savings and component savings. In particular, fixed gears of dual gear planes can be divided into two fixed gears for single gear planes. Thereby, step changes can be improved. In addition, it is also possible to interchange the countershafts. The subtransmissions can also be interchanged, i.e., mirrored about their vertical axes. In the process, hollow shafts and solid shafts are interchanged. Through this, it is possible to dispose the smallest gear on the solid shaft to further optimize the use of the existing construction space. Furthermore, adjacent gear planes can be interchanged to optimize a shaft deflection and/or to optimally connect a shift actuating system. In addition, the respective arrangement position of the coupling devices on the gear plane can be varied. Furthermore, the effective direction of the coupling devices can also be changed.

The gear numbering used here were freely defined. It is also possible to add a crawler or crawler gear and/or an overdrive or overdrive gear, in order to improve the off-road properties or the acceleration behavior of a vehicle. In addition a first gear can be omitted to better optimize the entirety of the step changes. The gear numbering varies correspondingly with these measures.

Independent of the respective variant embodiments of the double clutch transmission, the driveshaft and the output shaft can preferably be disposed non-coaxially to each other, which realizes a particularly construction space saving arrangement. For example, the shafts thus disposed spatially after each other, can also be offset slightly to each other. With this arrangement, a direct gear with a transmission ratio of one can be realized using meshing, and in an advantageous way can be placed relatively freely onto the sixth to ninth gear. Other arrangement possibilities of the driveshaft and the output shaft are also conceivable.

Preferably the proposed double clutch transmission is equipped with integrated output stages. The output stage can comprise a fixed gear on the output shaft as an output gear, which meshes with a first output gear as a fixed gear of the first countershaft, as well as with a second output gear as a fixed gear of the second countershaft. However it is also possible that at least one of the output gears is formed as a shiftable gear.

In an advantageous manner, the lower forward gears and the reverse gears can be actuated using a startup clutch or shifting clutch, to consequently concentrate higher loads onto this clutch, and with it, to be able to implement the second clutch in a more cost-effective and construction space saving manner. In particular, the gear planes with the proposed double clutch transmission can be disposed such that start-up is possible via the inner transmission input shaft or also the outer transmission input shaft, and thus via the respectively better suited clutch, which is also enabled with a concentrically arranged, radially shifted, nested construction of the double clutch. In addition, the gear planes can be disposed correspondingly mirror symmetrical or interchanged.

Independent of the respective variant embodiment of the double clutch transmission, the provided gear planes, for example, can be interchanged.

### BRIEF DESCRIPTION OF THE DRAWINGS

The present invention is described in the following in more detail with reference to the drawings. They show:

FIG. 1 a schematic view of a first variant embodiment of a nine speed double clutch transmission according to the invention;

FIG. 2 a shift pattern of the first variant embodiment according to FIG. 1;

FIG. 3 a schematic view of a second variant embodiment of a nine speed double clutch transmission according to the invention;

FIG. 4 a shift pattern of the second variant embodiment according to FIG. 3;

FIG. 5 a schematic view of a third variant embodiment of a nine speed double clutch transmission according to the invention;

FIG. 6 a shift pattern of the third variant embodiment according to FIG. 5;

FIG. 7 a schematic view of a fourth variant embodiment of a nine speed double clutch transmission according to the invention;

FIG. 8 a shift pattern of the fourth variant embodiment according to FIG. 7;

FIG. 9 a schematic view of a fifth variant embodiment of a nine speed double clutch transmission according to the invention;

FIG. 10 a shift pattern of the fifth variant embodiment according to FIG. 9.

### DETAILED DESCRIPTION OF THE PREFERRED EMBODIMENTS

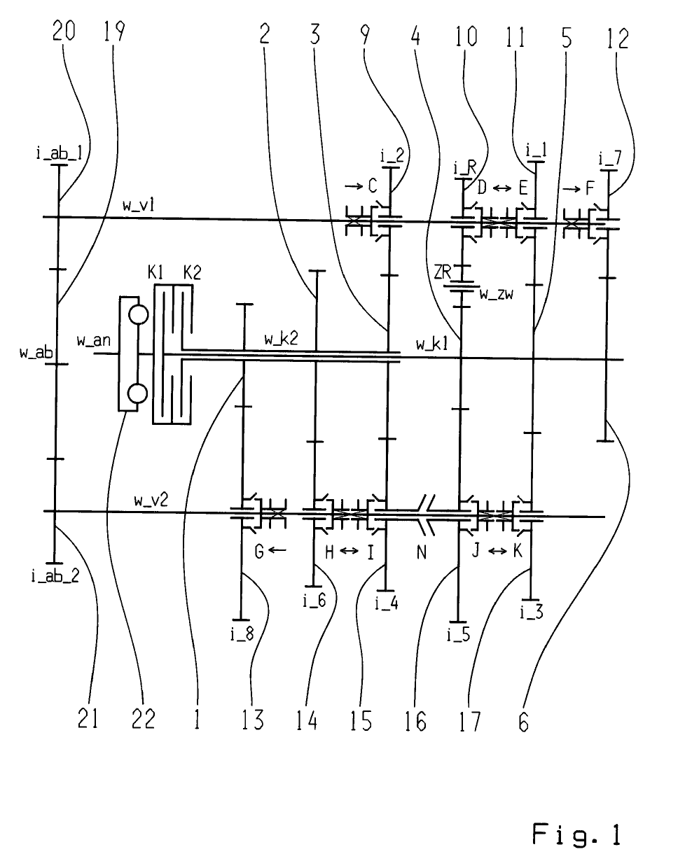

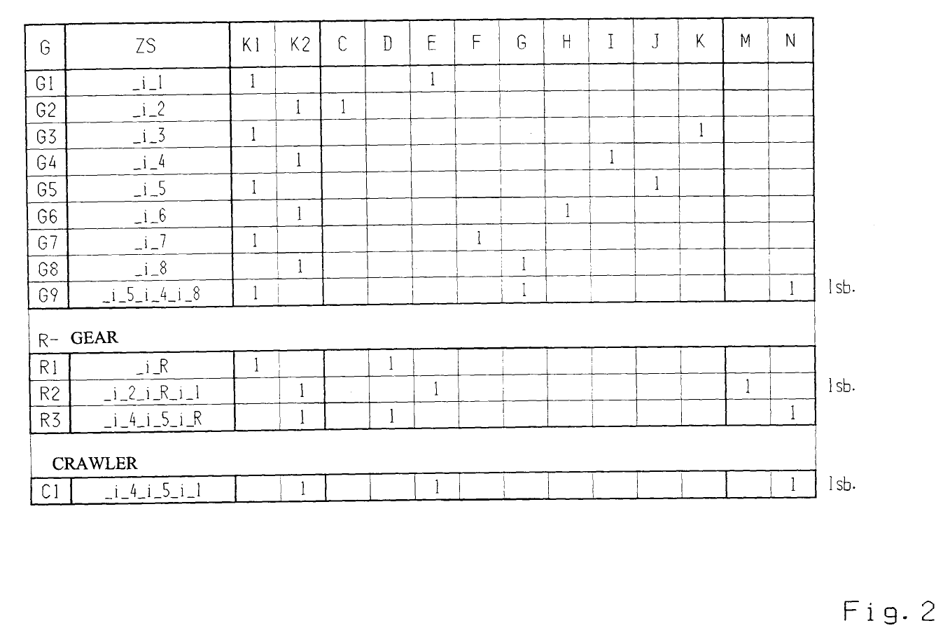

The FIGS. 1, 3, 5, 7 and 9 each show a possible variant embodiment of a nine speed double clutch transmission. The respective shift patterns for the different variant embodiments are shown in tabular form in the FIGS. 2, 4, 6, 8 and 10.

The nine speed double clutch transmission comprises two clutches K1, K2 whose input sides are connected to a driveshaft w_an, and whose output sides are respectively connected to one of two transmission input shafts w_k1, w_k2, disposed coaxially to each other. In addition, a torsional vibration damper 22 can be disposed on the driveshaft w_an. Furthermore, two countershafts w_v1, w_v2 are provided, on which toothed gearwheels formed as idler gears 8, 9, 10, 11, 12, 13, 14, 15, 16, 17, 18 are mounted in a rotational manner. Toothed gear wheels formed as fixed gears 1, 2, 3, 4, 5, 6 that connected to the two transmission input shafts w_k1, w_k2 in a rotationally fixed manner, mesh at least in part with the idler gears 8, 9, 10, 11, 12, 13, 14, 15, 16, 17, 18. In order to be able to connect the idler gears 8, 9, 10, 11, 12, 13, 14, 15, 16, 17, 18 to the respective countershaft w_v1, w_v2, multiple coupling devices B, C, D, E, F, G, H, I, J, K, L that can be activated are provided on the countershafts w_v1, w_v2. Furthermore, output gears 20, 21 are disposed on the two countershafts w_v1, w_v2 as constant pinions, which are, in each case, coupled to gearing of a fixed gear 19 of a output shaft w_ab.

Along with the coupling devices B, C, D, E, F, G, H, I, J, K, L which realize a rotationally fixed connection between a toothed gear wheel and the associated countershaft w_v1, w_v2, with the double clutch transmission at least one winding path gear-shift element M, N is provided for a rotationally fixed connection of two toothed gear wheels of a countershaft w_v1, w_v2, so that at least one winding path gear is realized.

According to the invention in the double clutch transmission only six gear planes 1-13, 2-14, 8-14, 9-15, 4-16, 10-16, 11-17, 12-6, 6-18 are provided, wherein for each variant embodiment three dual gear planes 8-14, 9-15, 10-16, 11-17 and three single gear planes 1-13, 2-14, 4-16, 12-6, 6-18 are provided, so that at least a power shiftable winding path gear can be shifted via at least one activated shift element M, N. As a shift element M, N, in each case, e.g., a pawl or similar can be used for the connection of two gears.

In all variant embodiments of the invention, the shift element N is, in each case, disposed on the second countershaft w_v2 to connect the idler gear 15 to the idler gear 16, when the shift element N is activated. Preferably, in one or also in several variant embodiments, in each case, an additional shift element M can be provided on the first countershaft w_v1 to realize further winding path gears. With the activated shift element M, the idler gears 9 and 10 can be connected together in a rotationally fixed manner.

In all variant embodiments according to the FIGS. 1 to 10, for the first gear plane 1-13 as a single gear plane, the fixed gear 1 of the second transmission input shaft w_k2 meshes with the idler gear 13 of the second countershaft w_v2. For the second gear plane 2-14 as a single gear plane, except with the third variant embodiment, the fixed gear 2 of the second transmission input shaft w_k2 meshes with the idler gear 14 of the second countershaft w_v2, wherein for the third variant embodiment, the fixed gear 2 meshes with the idler gear 14 of the second countershaft w_v2 and with an intermediate gear ZR on an intermediate shaft w_zw to reverse rotation, for implementing reverse transmission ratios. The intermediate gear ZR meshes also with the idler gear 8 of the first countershaft w_v1.

For the third gear plane 9-15 as a dual gear plane, in all variant embodiments, the fixed gear 3 of the second transmission input shaft wk2 meshes with both the idler gear 15 of the second countershaft w_v2 and the idler gear 9 of the first countershaft w_v1. In the first variant embodiment according to FIG. 1, for the fourth gear plane 10-16 as a dual gear plane, a fixed gear 4 of the first transmission input shaft w_v1 meshes with both the intermediate gear ZR on the intermediate shaft w_zw to reverse rotation for implementing reverse transmission ratios, as well as with an idler gear 16 of the second countershaft w_v2. The intermediate gear ZR meshes also with the idler gear 10 of the first countershaft w_v1.

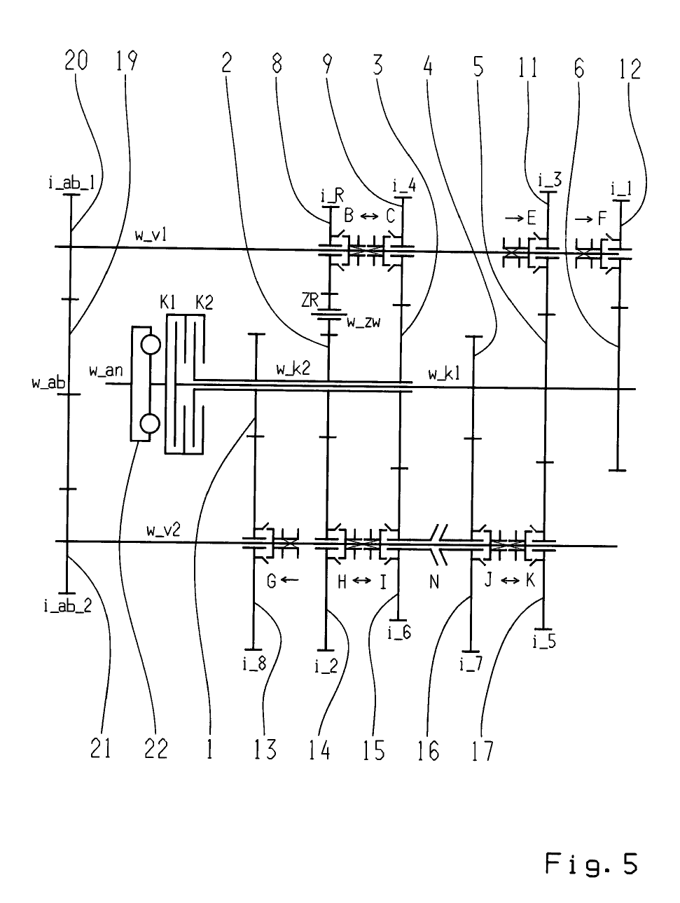

According to the second, fourth and fifth variant embodiments, with the fourth gear plane 10-16 as a dual gear plane, the fixed gear 4 of the first transmission input shaft w_k1 meshes with both the idler gear 10 of the first countershaft w_v1 as well as with the idler gear 16 of the second countershaft w_v2. With the third variant embodiment according to FIG. 5, in the fourth gear plane 4-16 as a single gear plane, a fixed gear 4 of the first transmission input shaft w_k1 meshes only with the idler gear 16 of the second countershaft w_v2.

In the first and third variant embodiments according to the FIGS. 1 and 5, in the fifth gear plane 11-17 as a dual gear plane, the fixed gear 5 of the first transmission input shaft w_k1 meshes both with the idler gear 11 of the first countershaft w_v1 and the idler gear 17 of the second countershaft w_v2. In the six gear plane 12-6 as a single gear plane, the fixed gear 6 of the first transmission input shaft w_k1 meshes only with the idler gear 12 of the first countershaft w_v1.

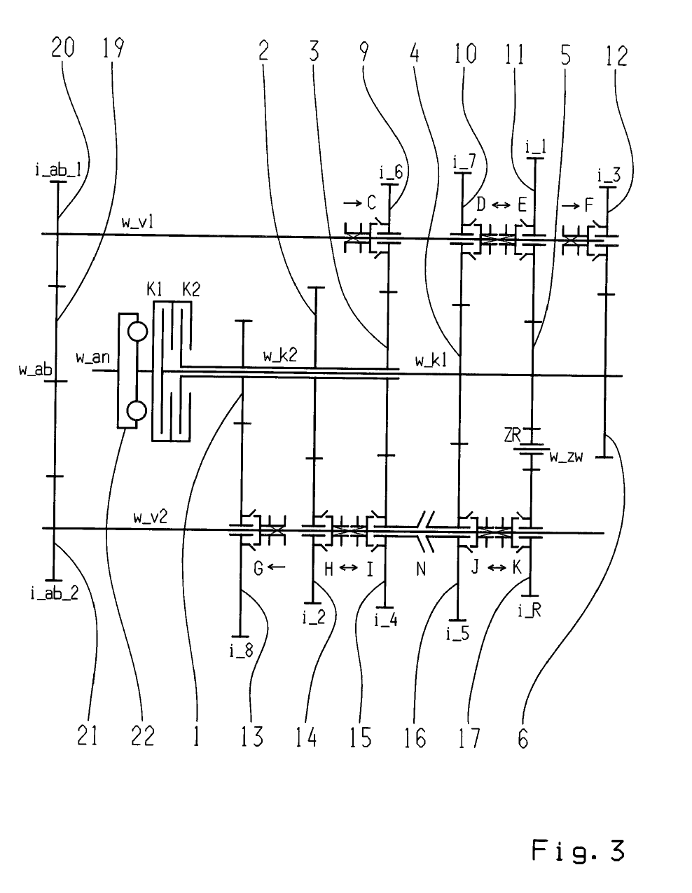

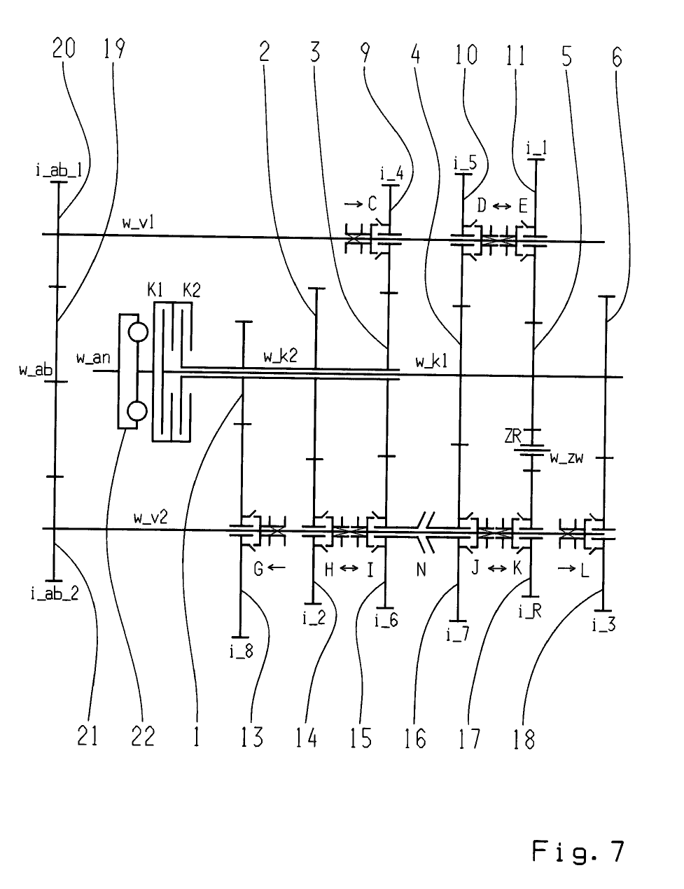

According to the second, fourth and fifth variant embodiments according to the FIGS. 3, 7 and 9, in the fifth gear plane 11-17 as a dual gear plane, the fixed gear 5 of the first transmission input shaft w_k1 meshes both with the idler gear 11 of the first countershaft w_v1 as well as with the intermediate gear ZR on the intermediate shaft w_zw to reverse rotation for the reverse transmission ratio, wherein the intermediate gear ZR meshes additionally with the idler gear 17 of the second countershaft w_v2. In the sixth gear plane 12-6 as a single gear plane, in the second and fifth variant embodiment, the fixed gear 6 of the first transmission input shaft w_k1 meshes with the idler gear 12 of the first countershaft w_v1. The fourth variant embodiment according to FIG. 7, differs from the second and fifth variant embodiment only in that in the sixth gear plane 6-18 as a single gear plane, the fixed gear 6 of the first transmission input shaft w_k1 meshes with the idler gear 18 of the second countershaft w_v2.

In all variant embodiments, a single acting coupling device G is assigned on the second countershaft w_v2 of the first gear plane 1-13; with this coupling device, the idler gear 13 is connected to the second countershaft w_v2 in a rotationally fixed manner, when the coupling device G is activated. Furthermore, a dual acting coupling device H-I is provided on the second countershaft w_v2 between the second gear plane 2-14 or 8-14 and the third gear plane 9-15. If the coupling device H is activated, the idler gear 14 can be connected with the second countershaft w_v2 in a rotationally fixed manner. If, in contrast, the coupling device I is activated, the idler gear 15 can be connected with the second countershaft w_v2 in a rotationally fixed manner. Finally, for all variant embodiments, a dual acting coupling device J-K is also provided between the fourth gear plane 10-16 or 4-16 and the fifth gear plane 11-17. If the coupling device J is activated, the idler gear 16 is connected to the second countershaft w_v2 in a rotationally fixed manner, and when the coupling device K is activated, the idler gear 17 is connected to the second countershaft w_v2 in a rotationally fixed manner.

For the fourth variant embodiment according to FIG. 7, additionally on the second countershaft w_v2 of the sixth gear plane 6-18, a single acting coupling device L is assigned, which in the activated state connects the idler gear 18 to the second countershaft w_v2 in a rotationally fixed manner.

In the first, second, fourth and fifth variant embodiments according to the FIGS. 1, 3, 7 and 9, a single acting coupling device C is assigned to the third gear plane 9-15 on the first countershaft w_v1. If the coupling device C is activated, the idler gear 9 is connected with the first countershaft w_v1 in a rotationally fixed manner. In addition, a dual acting coupling device D-E is provided between the fourth gear plane 10-16 and the fifth gear plane 11-17. If the coupling device D is activated, the idler gear 10 is connected to the first countershaft w_v1 in a rotationally fixed manner, and if the coupling device E is activated, the idler gear 11 is connected to the first countershaft w_v1 in an rotationally fixed manner. In addition, in the first, second, and fifth variant embodiments according to the FIGS. 1, 3 and 9, a single acting coupling device F is assigned to the six gear plane 12-6, and in its activated state the idler gear 12 is connected to the first countershaft w_v1 in a rotationally fixed manner.

In the third variant embodiment according to FIG. 5, a dual acting coupling device B-C is provided between the second gear plane 8-14 and the third gear plane 9-15. If the coupling device B is activated, the idler gear 8 is connected to the first countershaft w_v1 in a rotationally fixed manner, and if the coupling device C is activated, the idler gear 9 is connected to the first countershaft w_v1 in a rotationally fixed manner. In addition, the gear plane 11-17 is assigned a single acting coupling device E, which in the activated state connects the idler gear 11 to the first countershaft w_v1 in a rotationally fixed manner. Finally, the sixth gear plane is also assigned a single acting coupling device F on the first countershaft w_v1, where the coupling device F, in the activated state, connects the idler gear 12 to the first countershaft w_v1 in a rotationally fixed manner.

In the double clutch transmission according to the invention, an integrated output stage can be provided with the output gear 20, which is connected to the first countershaft w_v1 in a rotationally fixed manner, and with the output gear 21, which is disposed on the second counter shaft w_v2. The output gear 20 and the output gear 21 each mesh with a fixed gear 19 of the output shaft w_ab. However, it is also possible that a shiftable connection is implemented between the output gear 20 or 21 and the associated countershaft w_v1 or w_v2.

Independent of the respective variant embodiment, with the double clutch transmission according to the invention it is feasible that at least the forward gears G1 to G9 can be power shifted. Depending on the variant embodiment, additionally, reverse gears and/or crawler gears are also implemented as power shiftable winding path gears. Details for each variant embodiment arise from the shifting schemes described in the following.

The table in FIG. 2 shows an exemplary shifting scheme for the first variant embodiment of the nine speed double clutch transmission according to FIG. 1.

It can be seen from the shifting scheme that the first forward gear G1 can be shifted using the first clutch K1 and using the activated coupling device E, that the second forward gear G2 can be shifted using the second clutch K2 and using the activated coupling device C, that the third forward gear G3 can be shifted using the first clutch K1 and using the activated coupling device K, that the fourth forward gear G4 can be shifted using the second clutch K2 and using the activated coupling device I, that the fifth forward gear G5 can be shifted using the first clutch K1 and using the activated coupling device J, that the sixth forward gear G6 can be shifted using the second clutch K2 and using the activated coupling device H, that the seventh forward gear G7 can be shifted using the first clutch K1 and using the activated coupling device F, that the eighth forward gear G8 can be shifted using the second clutch K2 and using the activated coupling device G, and that the ninth forward gear G9 can be implemented as a winding path gear using the first clutch K1 and using the activated coupling device G as well as using the activated shift element N.

With the first variant embodiment, it can be seen further from the table in FIG. 2, that a reverse gear R1 can be shifted using the first clutch K1 and using the activated coupling device D. A next reverse gear R2 can be shifted as a winding path gear using the second clutch K2 and using the activated coupling device E, as well as using an activated shift element M. Beyond that, a further reverse gear R3, can be shifted as a winding path gear using the second clutch K2 and the activated coupling device D, as well as using the activated shift element N. In an advantageous manner, the reverse gear R2 can be implemented as a winding path gear that can be power shifted to the first forward gear G1 (R2 lsb. to G1). In addition, the reverse gear R3 can be implemented power shiftable to the reverse gear R1.

Beyond this, with the proposed double clutch transmission according to the first variant embodiment, a crawler gear C1 can be shifted as a winding path gear using the second clutch K2, using the activated coupling device E, and using the activated shift element N. In advantageous manner, power shifting between the first crawler gear C1 and the first forward gear G1 can occur under load, i.e., without interruption of the tractive force. (C1 lsp. to G1).

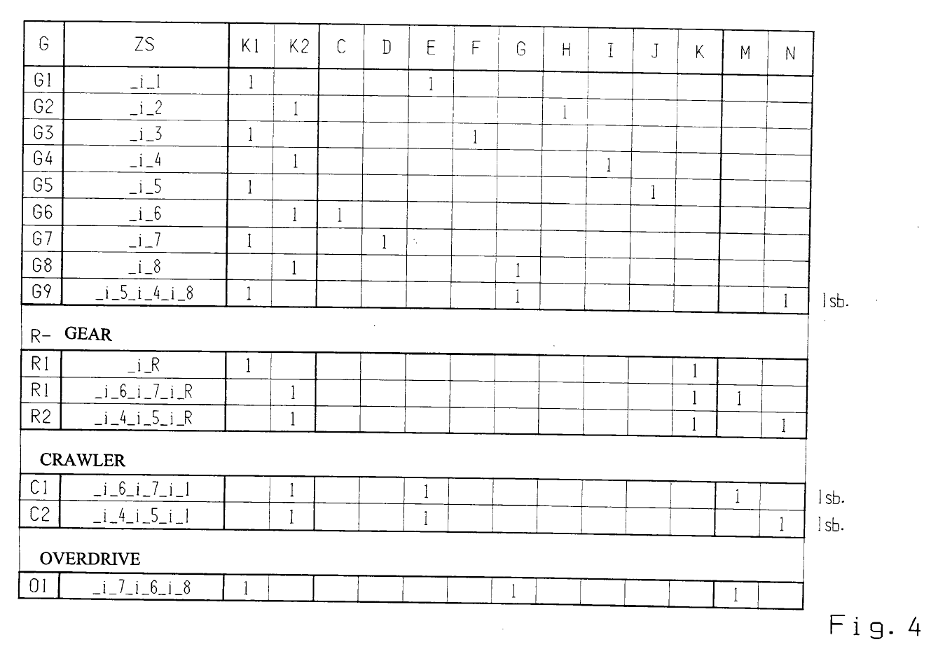

The table in FIG. 4 shows an exemplary shifting scheme for the second variant embodiment of the nine speed double clutch transmission according to FIG. 3.

It can be seen from the shifting scheme that the first forward gear G1 can be shifted using the first clutch K1 and using the activated coupling device E, that the second forward gear G2 can be shifted using the second clutch K2 and using the activated coupling device H, that the third forward gear G3 can be shifted using the first clutch K1 and using the activated coupling device F, that the fourth forward gear G4 can be shifted using the second clutch K2 and using the activated coupling device I, that the fifth forward gear G5 can be shifted using the first clutch K1 and using the activated coupling device J, that the sixth forward gear G6 can be shifted using the second clutch K2 and using the activated coupling device C, that the seventh forward gear G7 can be shifted using the first clutch K1 and using the activated coupling device D, that the eighth forward gear G8 can be shifted using the second clutch K2 and using the activated coupling device G, and that the ninth forward gear G9 can be implemented as a winding path gear using the first clutch K1 and using the activated coupling device G as well as using the activated shift element N.

With the second variant embodiment, it can further be seen from the table in FIG. 4, that a reverse gear R1 can be shifted using the first clutch K1 and using the activated coupling device K. Beyond that, a further reverse gear R2, for example, can be shifted as a winding path gear using the second clutch K2 and using the activated coupling device K as well as an activated shift element M. In addition, a next reverse gear R3 can be shifted as a winding path gear using the second clutch K2 and using the activated coupling device K as well as using the activated shift element N. Additionally, the reverse gears R2 and R3 can be power shifted to the reverse gear R1.

Furthermore, a crawler gear C1 can be shifted as a winding path gear using the second clutch K2 and using the activated coupling device E, as well as using an activated shift element M. Beyond that, a crawler gear C2 can be shifted as a winding path gear using the second clutch K2 and using the activated coupling device E, as well as using an activated shift element N. Both crawler gears C1, C2 can be power shifted to the first forward gear G1.

In addition, an overdrive gear O1 can be shifted as a winding path gear using the first clutch K1 and using the activated coupling device G, as well as using an activated shift element M.

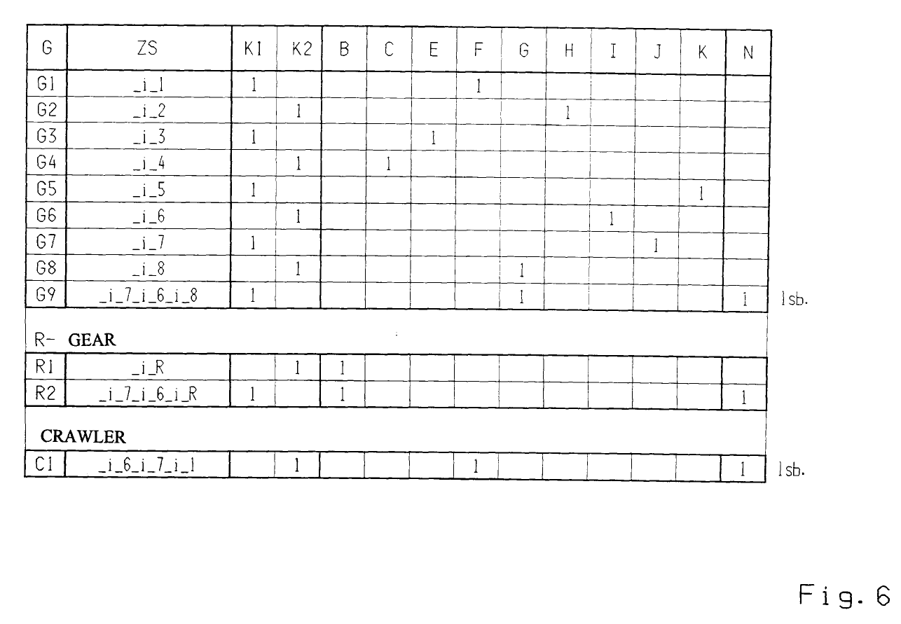

The table in FIG. 6 shows an exemplary shifting scheme for the third variant embodiment of the nine speed double clutch transmission according to FIG. 5.

It can be seen from the shifting scheme that the first forward gear G1 can be shifted using the first clutch K1 and using the activated coupling device F, that the second forward gear G2 can be shifted using the second clutch K2 and using the activated coupling device H, that the third forward gear G3 can be shifted using the first clutch K1 and using the activated coupling device E, that the fourth forward gear G4 can be shifted using the second clutch K2 and using the activated coupling device C, that the fifth forward gear G5 can be shifted using the first clutch K1 and using the activated coupling device K, that the sixth forward gear G6 can be shifted using the second clutch K2 and using the activated coupling device I, that the seventh forward gear G7 can be shifted using the first clutch K1 and using the activated coupling device J, that the eighth forward gear G8 can be shifted using the second clutch K2 and using the activated coupling device G, and that the ninth forward gear G9 can be implemented as a winding path gear using the first clutch K1 and using the activated coupling device G as well as using the activated shift element N.

With the third variant embodiment, it can further be seen from the table in FIG. 6, that a reverse gear R1 can be shifted using the second clutch K2 and using the activated coupling device B. In addition, a next reverse gear R2 can be shifted as a winding path gear using the first clutch K1 and using the activated coupling device B as well as using the activated shift element N. In addition, both reverse gears R1 and R2 can be power shiftable to each other.

Furthermore, a crawler gear C1 can be shifted as a winding path gear using the second clutch K2 and using the activated coupling device F, as well as using the activated shift element N. The crawler gear C1 can be power shifted to the first forward gear G1.

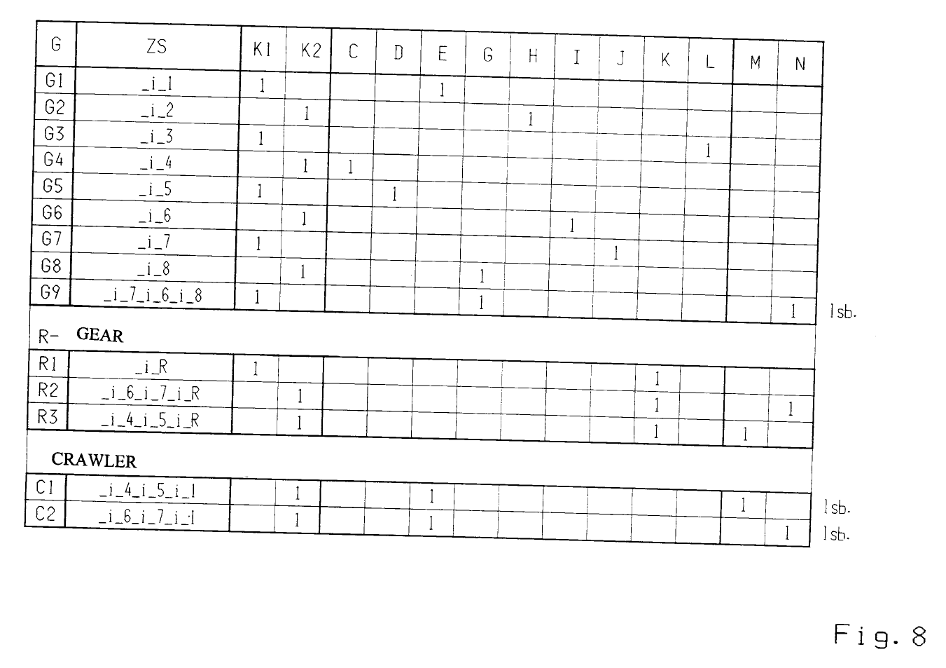

The table in FIG. 8 shows an exemplary shifting scheme for the fourth variant embodiment of the nine speed double clutch transmission according to FIG. 7.

It can be seen from the shifting scheme that the first forward gear G1 can be shifted using the first clutch K1 and using the activated coupling device E, that the second forward gear G2 can be shifted using the second clutch K2 and using the activated coupling device H, that the third forward gear G3 can be shifted using the first clutch K1 and using the activated coupling device L, that the fourth forward gear G4 can be shifted using the second clutch K2 and using the activated coupling device C, that the fifth forward gear G5 can be shifted using the first clutch K1 and using the activated coupling device D, that the sixth forward gear G6 can be shifted using the second clutch K2 and using the activated coupling device I, that the seventh forward gear G7 can be shifted using the first clutch K1 and using the activated coupling device J, that the eighth forward gear G8 can be shifted using the second clutch K2 and using the activated coupling device G, and that the ninth forward gear G9 can be implemented as a winding path gear using the first clutch K1 and using the activated coupling device G as well as using the activated shift element N.

With the fourth variant embodiment, it can further be seen from the table in FIG. 8, that a reverse gear R1 can be shifted using the first clutch K1 and using the activated coupling device K, and/or that a further reverse gear R2 can be shifted as a winding path gear using the second clutch K2 and using the activated coupling device K, as well as the activated shift element N. In addition, a further reverse gear R3 can be shifted as a winding path gear using the second clutch K2 and using the activated coupling device K as well as using the activated shift element M. Further, the reverse gears R2 and R3 can be power shifted to the reverse gear R1.

Beyond this, with the proposed double clutch transmission according to the fourth variant embodiment, a crawler gear C1 can be shifted as a winding path gear using the second clutch K2, using the activated coupling device E, and using the activated shift element M. In addition, a further crawler gear C2 can be shifted as a winding path gear using the second clutch K2 and using the activated coupling device E, as well as using an activated shift element N. The crawler gears C1, C2 can be power shifted to the first forward gear G1.

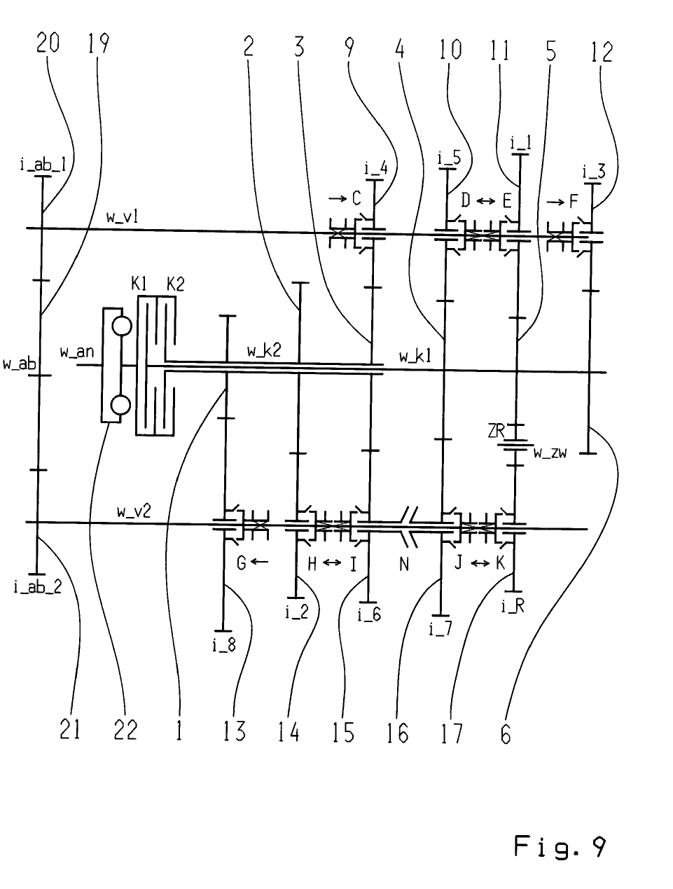

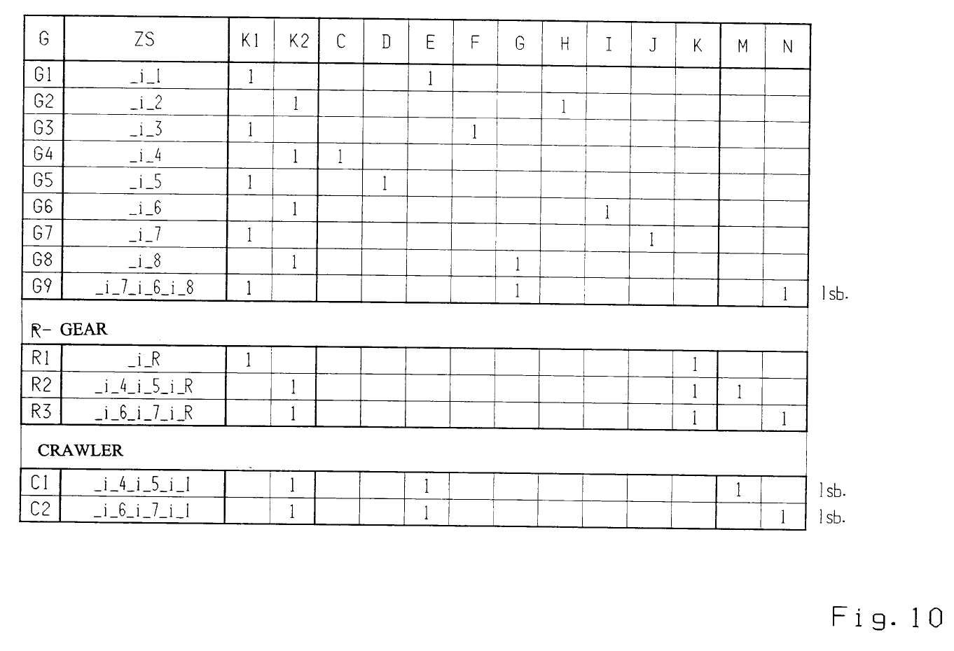

The table in FIG. 10 shows an exemplary shifting scheme for the fifth variant embodiment of the nine speed double clutch transmission according to FIG. 9.

It can be seen from the shifting scheme that the first forward gear G1 can be shifted using the first clutch K1 and using the activated coupling device E, that the second forward gear G2 can be shifted using the second clutch K2 and using the activated coupling device H, that the third forward gear G3 can be shifted using the first clutch K1 and using the activated coupling device F, that the fourth forward gear G4 can be shifted using the second clutch K2 and using the activated coupling device C, that the fifth forward gear G5 can be shifted using the first clutch K1 and using the activated coupling device D, that the sixth forward gear G6 can be shifted using the second clutch K2 and using the activated coupling device I, that the seventh forward gear G7 can be shifted using the first clutch K1 and using the activated coupling device J, that the eighth forward gear G8 can be shifted using the second clutch K2 and using the activated coupling device G, and that the ninth forward gear G9 can be implemented as a winding path gear using the first clutch K1 and using the activated coupling device G as well as using the activated shift element N.

With the fifth variant embodiment, it can further be seen from the table in FIG. 10, that a reverse gear R1 can be shifted using the first clutch K1 and using the activated coupling device K. Beyond that, a further reverse gear R2 can be shifted as a winding path gear using the second clutch K2 and using the activated coupling device K, as well as using an activated shift element M. Furthermore, a reverse gear R3 can be shifted as a winding path gear using the second clutch K2 and using the activated coupling device K, as well as using the activated shift element N. Additionally, the reverse gears R2, R3 and R1 can be implemented power shiftable among themselves.

Furthermore, a crawler gear C1 can be shifted as a winding path gear using the second clutch K2 and using the activated coupling device E, as well as using an activated shift element M. Beyond that, a further crawler gear C2 can be shifted as a winding path gear using the second clutch K2 and using the activated coupling device E, as well as using an activated shift element N. The crawler gears C1 and C2 can be power shifted to the first forward gear G1 (C1, C2 lsb. to G1).

From the shift pattern according to FIG. 2 it can be seen in detail that for the first forward gear G1, based on the first clutch K1, the gear stage i_1 is used, for the second forward gear G2 the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, for the seventh forward gear G7, the gear stage i_7 is used, and for the eight forward gear G8, the gear stage i_8 is used. For the ninth forward gear G9, based on the first clutch K1, the gear stages, or gear stages, i_5, i_4 and i_8 are used, wherein with the first variant embodiment the two subtransmissions are coupled via the shift element N. In addition, for the reverse gear R1, the gear stage i_R is used. Furthermore, for the further reverse gear R2, based on the second clutch K2, the gear stages i_2, i_R and i_1 are used, where a shift element M is activated for coupling the two subtransmissions. Beyond that, for the next reverse gear R3, based on the second clutch K2, the gear stages i_4, i_5 and i_R are used, wherein the shift element N is activated for coupling the two subtransmissions. For the crawler gear C1, based on the second clutch K2, the gear stages i_4, i_5 and i_1 are used, wherein the two subtransmissions are coupled using the shift element N.

From the shift pattern according to FIG. 4 it can be seen in detail that for the first forward gear G1, based on the first clutch K1, the gear stage i_1 is used, for the second forward gear G2 the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, for the seventh forward gear G7, the gear stage i_7 is used, and for the eight forward gear G8, the gear stage i_8 is used. For the ninth forward gear G9, based on the first clutch K1, the gear stages, i_5, i_4 and i_8 are used, where in the first variant embodiment the two subtransmissions are coupled via the shift element N. In addition, based on the first clutch K1, the gear stage i_R is used for the reverse gear R1. Furthermore, for the additional reverse gear R2, based on the second clutch K2, the gear stages i_6, i_7 and i_R are used, wherein the two subtransmissions are coupled using a shift element M. For the reverse gear R3, based on the second clutch K2, the gear stages i_4, i_5 and i_R are used, wherein the two subtransmissions are coupled using the shift element N.

Furthermore, for the further crawler gear C1, based on the second clutch K2, the gear stages i_6, i_7 and i_1 are used, wherein the two subtransmissions are coupled using a shift element M. For the crawler gear C2, based on the second clutch K2, the gear stages i_4, i_5 and i_1 are used, wherein the shift element N is used for coupling the two subtransmissions. Finally, for the overdrive gear O1, based on the first clutch K1, the gear stages i_7, i_6 and i_8 are used, wherein the two subtransmissions are coupled using a shift element M.

From the shift pattern according to FIG. 6 it can be seen in detail that for the first forward gear G1 based on the first clutch K1, the gear stage i_1 is used, for the second forward gear G2 the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, for the seventh forward gear G7, the gear stage i_7 is used, and for the eight forward gear G8, the gear stage i_8 is used. For the ninth forward gear G9, based on the first clutch K1, the gear stages i_7, i_6 and i_8 are used, wherein the two subtransmissions are coupled using the shift element N. In addition, for the reverse gear R1, based on the second clutch K2, the gear stage i_R, and for the reverse gear R2, based on the first clutch K1, the gear stages i_7, i_6 and i_R are used, wherein for the reverse gear, the shift element N is activated for coupling the two subtransmissions. Furthermore, for the crawler gear C1, based on the second clutch K2, the gear stages i_6, i_7 and i_1 are used, wherein the two subtransmissions are coupled using the shift element N.

From the shift pattern according to FIG. 8 it can be seen in detail that for the first forward gear G1 based on the first clutch K1, the gear stage i_1 is used, for the second forward gear G2 the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, for the seventh forward gear G7, the gear stage i_7 is used, and for the eight forward gear G8, the gear stage i_8 is used. For the ninth forward gear G9, based on the first clutch K1, the gear stages i_7, i_6 and i_8 are used, wherein the two subtransmissions are coupled using the shift element N. In addition, for the reverse gear R1, based on the first clutch K1, the gear stage i_R is used. Furthermore, for the additional reverse gear R2, based on the second clutch K2, the gear stages i_6, i_7 and i_R are used, wherein the two subtransmissions are coupled using the shift element N. For the further reverse gear R3, based on the second clutch K2, the gear stages i_4, i_5 and i_R are used, wherein the two subtransmissions are coupled using the shift element M. For the crawler gear C1, based on the second clutch K2, the gear stages i_4, i_5 and i_1 are used, wherein the two subtransmissions are coupled together using the shift element M. Furthermore, for the crawler gear C2, based on the second clutch K2, the gear stages i_6, i_7 and i_1 are used, wherein the two subtransmissions are coupled together using the shift element N.

From the shift pattern according to FIG. 10 it can be seen in detail that for the first forward gear G1 based on the first clutch K1, the gear stage i_1 is used, for the second forward gear G2 the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, for the seventh forward gear G7, the gear stage i_7 is used, and for the eight forward gear G8, the gear stage i_8 is used. For the ninth forward gear G9, based on the first clutch K1, the gear stages i_7, i_6 and i_8 are used, wherein the two subtransmissions are coupled using the shift element N. In addition, for the reverse gear R1, based on the first clutch K1, the gear stage i_R is used. For the reverse gear R2, based on the second clutch K2, the gear stages i_4, i_5 and i_R are used, wherein the subtransmissions are coupled using the shift element M. For the next reverse gear R3, based on the second clutch K2, the gear stages i_6, i_7 and i_R are used, wherein the two subtransmissions are coupled together using the shift element N. For the crawler gear C1, based on the second clutch K2, the gear stages i_4, i_5 and i_1 are used, wherein the two subtransmissions are coupled together using the shift element M. Furthermore, for the next crawler gear C2, based on the second clutch K2, the gear stages i_6, i_7 and i_1 are used, wherein the subtransmissions are coupled together using the shift element N.

In summary, for the first and second variant embodiments according to the FIGS. 1 to 4, in each case a winding path gear results for the ninth forward gear G9 using the gear stages (i_5, i_4, i_8) of the fifth, fourth and eight gears. The at least one crawler gear C1, C2 that is power shiftable to the first forward gear G1 can be used as a possible tenth forward gear in order to realize improved driving characteristics in off-road vehicles. In addition, reverse gears R1, R2, R2 are provided power shiftable to each other.

Further, with the first variant embodiment according to FIGS. 1 and 2, a good adjustability of the stepping of the upper gears results due to a free selection of the transmission ratio of the gear stages i_6, i_7 and i_8 on single gear planes.

In detail, the first variant embodiment results in that on the first gear plane 1-13 as a single gear plane, that the idler gear 13 is used for two forward gears G8, G9. On the second gear plane 2-14 as a single gear plane, the idler gear 14 is used for a forward gear G6. On the third gear plane 9-15 as a dual gear plane, the idler gear 9 is used for a forward gear G2 as well as for a reverse gear R2, and the idler gear 15 is used for three forward gears G4, G9, C1 as well as for a reverse gear R3. On the fourth gear plane 10-16 as a dual gear plane, the idler gear 10 is used for three reverse gears R1, R2, R3, and the idler gear 16 is used for three forward gears G5, G9, C1 as well as for a reverse gear R3. On the fifth gear plane 11-17 as a dual gear plane, the idler gear 11 is used for two forward gears G1, C1 as well as for a reverse gear R2, and the idler gear 17 is used for a forward gear G3. Finally, on the sixth gear plane 12-6 as a single gear plane, the idler gear 12 is used for the forward gear G7.

In summary, the second variant embodiment according to the FIGS. 3 and 4, yields free transmission ratio selection of the gears or gear stages i_2, i_3, and i_8 on single gear planes, whereby a good adjustability of the steps of the lower gears is realized.

In detail, the second variant embodiment results in that on the first gear plane 1-13 as a single gear plane, the idler gear 13 is used for three forward gears G8, G9, O1. On the second gear plane 2-14 as a single gear plane, the idler gear 14 is used for a forward gear G2. On the third gear plane 9-15 as a dual gear plane, the idler gear 9 is used for three forward gears G6, C1, O1 as well as for a reverse gear R2, and the idler gear 15 is used for three forward gears G4, G9, C2 as well as for a reverse gear R3. On the fourth gear plane 10-16 as a dual gear plane, the idler gear 10 is used for three forward gears G7, C1, O1 as well as for a reverse gear R2, and the idler gear 16 is used for three forward gears G5, G9, C2 as well as for a reverse gear R3. On the fifth gear plane 11-17 as a dual gear plane, the idler gear 11 is used for three forward gears G1, C1, C2, and the idler gear 17 is used for three reverse gears R1, R2, R3. Finally, on the sixth gear plane 12-6 as a single gear plane, the idler gear 12 is used for a forward gear G3.

In summary, with the third, fourth and fifth variant embodiments according to the FIGS. 5 to 10, a winding path gear results in the ninth forward gear G9 using the gear steps or gear stages i_7, i_{— 6 and i}_8. Further, for the first forward gear G1, a power shiftable crawler gear C1, C2 results using the gear stages i_6, i_7 and i_1 as a possible tenth forward gear. Thereby, improved driving characteristics are attained in off-road vehicles.

In addition, with the third variant embodiment according to the FIGS. 5 and 6, a free transmission selection of the gear stages i_7 and i_8 on single gear planes is provided, resulting in a good adjustability of the stepping of the upper gears, among others, of the ninth forward gear G9 as a winding path gear.

In detail, the third variant embodiment results in that on the first gear plane 1-13 as a single gear plane, that the idler gear 13 is used for two forward gears G8, G9. On the second gear plane 8-14 as a dual gear plane, the idler gear 8 is used for two reverse gears R1, R2, and the idler gear 14 is used for a forward gear G2. On the third gear plane 9-15 as a dual gear plane, the idler gear 9 is used for a forward gear G4, and the idler gear 15 is used for three forward gears G6, G9, C1 as well as for a reverse gear R2. On the fourth gear plane 4-16 as a single gear plane, the idler gear 16 is used for three forward gears G7, G9, C1 as well as for a reverse gear R2. On the fifth gear plane 11-17 as a dual gear plane, the idler gear 11 is used for a forward gear G3, and the idler gear 17 is used for a forward gear G5. Finally, on the sixth gear plane 12-6 as a single gear plane, the idler gear 12 is used for two forward gears G1, C1.

In summary, the fourth variant embodiment according to the FIGS. 7 and 8, yields a favorable arrangement for the bearing and shaft design because the gear stages i_1, i_2, i_3 and i_R are disposed on the ends of the shafts.

In detail, the fourth variant embodiment results in that on the first gear plane 1-13 as a single gear plane, the idler gear 13 is used for two forward gears G8, G9. On the second gear plane 2-14 as a single gear plane, the idler gear 14 is used for a forward gear G2. On the third gear plane 9-15 a dual gear plane, the idler gear 9 is used as for two forward gears G4, C1, as well as for a reverse gear R3, and the idler gear 15 is used for three forward gears G6, G9, C2 as well as for a reverse gear R2. On the fourth gear plane 10-16 as a dual gear plane, the idler gear 10 is used for two forward gears G5, C1 as well as for a reverse gear R3, and the idler gear 16 is used for three forward gears G7, G9, C2 as well as for a reverse gear R2. On the fifth gear plane 11-17 as a dual gear plane, the idler gear 11 is used for three forward gears G1, C1, C2, and the idler gear 17 is used for three reverse gears R1, R2, R3. Finally, on the sixth gear plane 6-18 as a single gear plane, the idler gear 18 is used for a forward gear G3.

In summary, the fifth variant embodiment according to the FIGS. 9 and 10, results in an improved adjustability of the stepping due to the arrangement of the third gear stage i_3 on a single gear plane on the first countershaft w_v1.

In detail, the fifth variant embodiment results in that on the first gear plane 1-13 as a single gear plane, the idler gear 13 is used for two forward gears G8, G9. On the second gear plane 2-14 as a single gear plane, the idler gear 14 is used for a forward gear G2. On the third gear plane 9-15 as a dual gear plane, the idler gear 9 is used for two forward gears G4, C1 as well as for a reverse gear R2, and the idler gear 15 is used for three forward gears G6, G9, C2 as well as for a reverse gear R3. On the fourth gear plane 10-16 as a dual gear plane, the idler gear 10 is used for two forward gears G5, C1 as well as for a reverse gear R2, and the idler gear 16 is used for three forward gears G7, G9, C2 as well as for a reverse gear R3. On the fifth gear plane 11-17 as a dual gear plane, the idler gear 11 is used for three forward gears G1, C1, C2, and the idler gear 17 is used for three reverse gears R1, R2, R3. Finally, on the sixth gear plane 12-6 as a single gear plane, the idler gear 12 is used for the forward gear G3.

It is possible with one or several of the variant embodiments that at least one additional gear stage or an intermediate step gear is used for winding path gears, which is/are not used in a direct gear.

With all variant embodiments of the double clutch transmission, due to the provided multiple uses of individual idler gears, fewer gear planes, and thus fewer components are necessary for the same number of gears, resulting in an advantageous cost savings and construction space savings.

Independent of the respective variant embodiment, the number “1” in a field of the respective table of the shift pattern according to the FIGS. 2, 4, 6, 8 and 10, indicates that the associated clutch K1, K2, or the associated coupling device B, C, D, E, F, G, H, I, J, K, L, or the associated shift element M, N, in each case, is engaged. In contrast, a blank field in the respective table of the shift pattern according to the FIGS. 2, 4, 6, 8 and 10, indicates that the associated clutch K1, K2, or the associated coupling device B, C, D, E, F, G, H, I, J, K, L, or the associated shift element M, N, in each case, is disengaged. Furthermore, in many cases the possibility exists to insert further coupling or shift elements, without influencing the flow of power. As a result of this, a gear preselection is enabled.

### REFERENCE CHARACTERS

1 Fixed gear of the second transmission input shaft
2 Fixed gear of the second transmission input shaft
3 Fixed gear of the second transmission input shaft
4 Fixed gear of the first transmission input shaft
5 Fixed gear of the first transmission input shaft
6 Fixed gear of the first transmission input shaft
8 Idler gear of the first countershaft
9 Idler gear of the first countershaft
10 Idler gear of the first countershaft
11 Idler gear of the first countershaft
12 Idler gear of the first countershaft
13 Idler gear of the second countershaft
14 Idler gear of the second countershaft
15 Idler gear of the second countershaft
16 Idler gear of the second countershaft
17 Idler gear of the second countershaft
18 Idler gear of the second countershaft
19 Fixed gear of the output shaft
20 Output gear of the first countershaft
21 Output gear of the first countershaft
22 Torsional vibration damper
K1 First clutch
K2 Second clutch
w_an Drive shaft
w_ab Output shaft
w_v1 First countershaft
w_v2 Second countershaft
w_k1 First transmission input shaft
w_k2 Second transmission input shaft
B Coupling device
C Coupling device
D Coupling device
E Coupling device
F Coupling device
G Coupling device
H Coupling device
I Coupling device
J Coupling device
K Coupling device
L Coupling device
i_1 Gear stage first forward gear
i_2 Gear stage second forward gear
i_3 Gear stage third forward gear
i_4 Gear stage fourth forward gear
i_5 Gear stage fifth forward gear
i_6 Gear stage sixth forward gear
i_7 Gear stage seventh forward gear
i_8 Gear stage eighth forward gear
G1 First forward gear
G2 Second forward gear
G3 Third forward gear
G4 Fourth forward gear
G5 Fifth forward gear
G6 Sixth forward gear
G7 Seventh forward gear
G8 Eighth forward gear
G9 Ninth forward gear
C1 Crawler gear
C2 Crawler gear
O1 Overdrive gear
R1 Reverse gear
R2 Reverse gear
R3 Reverse gear
w_zw Intermediate shaft
ZR Intermediate gear
ZS Gear stage used
M Shift element
N Shift element
lsb. Power shiftable

1-22. (canceled)

23. A double clutch transmission comprising:
first and second clutches (K1, K2) each having an input side connected to a drive shaft (w_an) and an output side connected to one of first and second transmission input shafts (w_K1, w_K2) arranged coaxially with one another;
at least first and second countershafts (w_v1, w_v2) rotatably supporting toothed idler gearwheels (8, 9, 10, 11, 12, 13, 14, 15, 16, 17, 18);
toothed fixed gearwheels (1, 2, 3, 4, 5, 6), being connected in a rotationally fixed manner to the first and the second input shafts (w_K1, w_K2) and engaging at least one of the idler gears (8, 9, 10, 11, 12, 13, 14, 15, 16, 17, 18);
a plurality of coupling devices (B, C, D, E, F, G, H, I, J, K, L), each coupling one of the idler gearwheels (8, 9, 10, 11, 12, 13, 14, 15, 16, 17, 18) to one of the first and the second countershafts (w_v1, w_v2) in a rotationally fixed manner;
the first and the second countershafts (w_v1, w_v2) each supporting a power take-off gear (20, 21) which meshes with gearing of an output shaft (w_ab);
the first and the second countershafts (w_v1, w_v2) supporting at least one shift element (N) for connecting two idler gearwheels in a rotationally fixed manner, such that a plurality of power shiftable forward gears (1, 2, 3, 4, 5, 6, 7, 8, 9) and at least one reverse gear (R1, R2, R3) are shiftable; and
six gear planes (1-13, 2-14, 8-14, 9-15, 4-16, 10-16, 11-17, 12-6, 6-18), three of the six gear planes being dual gear planes (8-14, 9-15, 10-16, 11-17), each of the three dual gear planes (8-14, 9-15, 10-16, 11-17) comprise one idler gearwheel (8, 9, 10, 11, 14, 15, 16, 17) of each of the first and the second countershafts (w_v1, w_v2) which is assigned a fixed gearwheel (2, 3, 4, 5) of one of the transmission input shafts (w_k1, w_k2), at least one idler gearwheel (8, 9, 10, 11, 13, 14, 15, 16, 17) in each of the three dual gear planes (8-14, 9-15, 10-16, 11-17) being utilized for at least two gears, and
three single gear planes (1-13, 2-14, 4-16, 12-6, 6-18) are provided in which an idler gearwheel (12, 13, 14, 16, 18) of the first and the second countershafts (w_v1, w_v2) is assigned a fixed gearwheel (1, 2, 4, 6) of one of the first and the second transmission input shafts (w_k1, w_k2) such that at least one power shiftable winding path gear is shiftable utilizing the at least one shift element (N).

24. The double clutch transmission according to claim 23, wherein an idler gearwheel (15) of a second subtransmission is connectable to an idler gearwheel (16) of a first subtransmission using the shift element (N) on the second countershaft (w_v2) such that a ninth forward gear (G9), a reverse gear (R2, R3) and a crawler gear (C1, C2), in each case, is shifted as a winding path gear using the shift element (N).

25. The double clutch transmission according to claim 23, wherein a first gear plane (1-13) and a second gear plane (2-14) are each a single gear plane, and a third gear plane (9-15) is a dual gear plane, and the first gear plane, the second gear plane and the third gear plane respectively comprise three fixed gears (1, 2, 3) on the second transmission input shaft (w_k2) of a second subtransmission.

26. The double clutch transmission according to claim 25, wherein a fourth gear plane (10-16) and a fifth gear plane (11-17) are each a dual gear plane, and a sixth gear plane (12-6, 6-18) is a single gear plane, and the fourth gear plane, the fifth gear plane and the sixth gear plane respectively comprise three fixed gears (4, 5, 6) on the first transmission input shaft (w_k1) of a first subtransmission.

27. The double clutch transmission according to claim 23, wherein a first gear plane (1-13), is a single gear plane, and a second gear plane (8-14) and a third gear plane (9-15) are each a dual gear plane, and the first gear plane, the second gear plane and the third gear plane respectively comprise three fixed gears (1, 2, 3) on a second transmission input shaft (w_k2) of the second subtransmission.

28. The double clutch transmission according to claim 27, wherein a fourth gear plane (4-16) is a single gear plane, and a fifth gear plane (11-17) is a dual gear plane, and a sixth gear plane (12-6) is a single gear plane, and the fourth gear plane, the fifth gear plane and the sixth gear plane respectively comprise three fixed gears (4, 5, 6) of the first transmission input shaft (w_k2) of a first subtransmission.

29. The double clutch transmission according to claim 23, wherein a first forward gear (G1) is shiftable via the first clutch (K1) and an activated fourth coupling device (E), a second forward gear (G2) is shiftable via the second clutch (K2) and an activated second coupling device (C), a third forward gear (G3) is shiftable via the first clutch (K1) and an activated tenth coupling device (K), a fourth forward gear (G4) is shiftable via the second clutch (K2) and an activated eighth coupling device (I), a fifth forward gear (G5) is shiftable via the first clutch (K1) and an activated ninth coupling device (J), a sixth forward gear (G6) is shiftable via the second clutch (K2) and an activated seventh coupling device (H), a seventh forward gear (G7) is shiftable via the first clutch (K1) and an activated fifth coupling device (F), an eighth forward gear (G8) is shiftable via the second clutch (K2) and an activated sixth coupling device (G), and a ninth forward gear (G9) is shifted as a winding path gear via the first clutch (K1) and the activated sixth coupling device (G) and the activated shift element (N).

30. The double clutch transmission according to claim 29, wherein, a first reverse gear (R1) is shiftable via the first clutch (K1) and an activated third coupling device (D),
a second reverse gear (R2) is shiftable as a winding path gear via the second clutch (K2) and the activated fourth coupling device (E) and an activated second shift element (M), and
a third reverse gear (R3) is shiftable as a winding path gear via the second clutch (K2) and the activated third coupling device (D) and the activated first shift element (N).

31. The double clutch transmission according to claim 29, wherein a crawler gear (C1) is shifted as a winding path gear via the second clutch (K2) and the activated fourth coupling device (E) as well as the activated shift element (N).

32. The double clutch transmission according to claim 23, wherein a first forward gear (G1) is shiftable via the first clutch (K1) and an activated fourth coupling device (E),
a second forward gear (G2) is shiftable via the second clutch (K2) and an activated seventh coupling device (H),
a third forward gear (G3) is shiftable via the first clutch (K1) and an activated fifth coupling device (F),
a fourth forward gear (G4) is shiftable via the second clutch (K2) and an activated eighth coupling device (I),
a fifth forward gear (G5) is shiftable via the first clutch (K1) and an activated ninth coupling device (J),
a sixth forward gear (G6) is shiftable via the second clutch (K2) and an activated second coupling device (C),
a seventh forward gear (G7) is shiftable via the first clutch (K1) and an activated third coupling device (D),
an eighth forward gear (G8) is shiftable via the second clutch (K2) and an activated sixth coupling device (G), and
a ninth forward gear (G9) is shifted as a winding path gear via the first clutch (K1) and the activated sixth coupling device (G) as well as the activated shift element (N).

33. The double clutch transmission according to claim 32, wherein a first reverse gear (R1) is shiftable via the first clutch (K1) and an activated tenth coupling device (K),
a second reverse gear (R2) is shifted as a winding path gear via the second clutch (K2) and the tenth coupling device (K) and a second activated shift element (M), and
a third reverse gear (R3) is shifted as a winding path gear via the second clutch (K2) and the activated tenth coupling device (K) and the activated first shift element (N).

34. The double clutch transmission according to claim 32, wherein a first crawler gear (C1) is shifted as a winding path gear via the second clutch (K2) and the activated fourth coupling device (E) and an activated second shift element (M), and
a third crawler gear (C2) is shifted as a winding path gear via the second clutch (K2) and the activated fourth coupling device (E) and the activated first shift element (N).

35. The double clutch transmission according to claim 32, wherein an overdrive gear (O1) is shifted as a winding path gear via the first clutch (K1) and the activated sixth coupling device (G) and the activated shift element (N).

36. The double clutch transmission according to claim 23, wherein a first forward gear (G1) is shiftable via the first clutch (K1) and an activated fifth coupling device (F),
a second forward gear (G2) is shiftable via the second clutch (K2) and an activated seventh coupling device (H),
a third forward gear (G3) is shiftable via the first clutch (K1) and an activated fourth coupling device (E),
a fourth forward gear (G4) is shiftable via the second clutch (K2) and an activated second coupling device (C),
a fifth forward gear (G5) is shiftable via the first clutch (K1) and an activated tenth coupling device (K),
a sixth forward gear (G6) is shiftable via the second clutch (K2) and an activated eighth coupling device (I),
a seventh forward gear (G7) is shiftable via the first clutch (K1) and an activated ninth coupling device (J),
an eighth forward gear (G8) is shiftable via the second clutch (K2) and an activated sixth coupling device (G), and
a ninth forward gear (G9) is shifted as a winding path gear via the first clutch (K1) and the activated sixth coupling device (G) and the activated shift element (N).

37. The double clutch transmission according to claim 36, wherein a first reverse gear (R1) is shiftable via the second clutch (K2) and an activated first coupling device (B), and
a second reverse gear (R2) is shifted as a winding path gear via the first clutch (K1) and the activated first coupling device (B) and the activated shift element (N).

38. The double clutch transmission according to claim 36, wherein a crawler gear (C1) is shifted as a winding path gear via the second clutch (K2) and the activated fifth coupling device (F) and the activated shift element (N).

39. The double clutch transmission according to claim 23, wherein a first forward gear (G1) is shiftable via the first clutch (K1) and an activated fourth coupling device (E),
a second forward gear (G2) is shiftable via the second clutch (K2) and an activated seventh coupling device (H),
a third forward gear (G3) is shiftable via the first clutch (K1) and an activated eleventh coupling device (L),
a fourth forward gear (G4) is shiftable via the second clutch (K2) and an activated second coupling device (C),
a fifth forward gear (G5) is shiftable via the first clutch (K1) and an activated third coupling device (D),
a sixth forward gear (G6) is shiftable via the second clutch (K2) and an activated eighth coupling device (I),
a seventh forward gear (G7) is shiftable via the first clutch (K1) and an activated ninth coupling device (J),
an eighth forward gear (G8) is shiftable via the second clutch (K2) and an activated sixth coupling device (G), and
a ninth forward gear (G9) is shifted as a winding path gear via the first clutch (K1) and the activated sixth coupling device (G) and the activated shift element (N).

40. The double clutch transmission according to claim 39, wherein, a first reverse gear (R1) is shiftable via the first clutch (K1) and an activated tenth coupling device (K),
a second reverse gear (R2) is shifted as a winding path gear via the second clutch (K2) and the activated tenth coupling device (K) and the activated shift element (N), and
a third reverse gear (R3) is shifted as a winding path gear via the second clutch (K2) and the activated tenth coupling device (K) as an activated second shift element (M).

41. The double clutch transmission according to claim 39, wherein a first crawler gear (C1) is shifted as a winding path gear via the second clutch (K2) and the activated fourth coupling device (E) and an activated second shift element (M), and
a second crawler gear (C2) is shifted as a winding path gear via the second clutch (K2) and the activated fourth coupling device (E) and the activated shift element (N).

42. The double clutch transmission according to claim 23, wherein a first forward gear (G1) is shiftable via the first clutch (K1) and an activated fourth coupling device (E),
a second forward gear (G2) is shiftable via the second clutch (K2) and an activated seventh coupling device (H),
a third forward gear (G3) is shiftable via the first clutch (K1) and an activated sixth coupling device (F),
a fourth forward gear (G4) is shiftable via the second clutch (K2) and an activated second coupling device (C),
a fifth forward gear (G5) is shiftable via the first clutch (K1) and an activated third coupling device (D),
a sixth forward gear (G6) is shiftable via the second clutch (K2) and an activated eighth coupling device (I),
a seventh forward gear (G7) is shiftable via the first clutch (K1) and an activated ninth coupling device (J),
an eighth forward gear (G8) is shiftable via the second clutch (K2) and an activated sixth coupling device (G), and
a ninth forward gear (G9) is shifted as a winding path gear via the first clutch (K1) and the activated sixth coupling device (G) and the activated shift element (N).

43. The double clutch transmission according to claim 42, wherein, a first reverse gear (R1) is shiftable via the first clutch (K1) and an activated tenth coupling device (K),
a second reverse gear (R2) is shifted as a winding path gear via the second clutch (K2) and the activated tenth coupling device (K) and an activated second shift element (M), and
a third reverse gear (R3) is shifted as a winding path gear via the second clutch (K2) and the activated tenth coupling device (K) and the activated first shift element (N).

44. The double clutch transmission according to claim 42, wherein a first crawler gear (C1) is shifted as a winding path gear via the second clutch (K2) and the activated fourth coupling device (E) and an activated second shift element (M), and
a second crawler gear (C2) is shifted as a winding path gear via the second clutch (K2) and the activated fourth coupling device (E) and the activated first shift element (N).
